(19) United States
(12) Patent Application Publication
(10) Pub. No.: US 2026/0166949 A1
(43) Pub. Date: Jun. 18, 2026

(54) SYSTEM AND METHOD FOR RAPID RECOVERY OF FLUID REFRIGERANT

(71) Applicant: Robert Bosch GmbH, Stuttgart (DE)

(72) Inventors: Jacob Hanson, Owatonna, MN (US); Valerio Doino, Rochester, MN (US)

(21) Appl. No.: 18/982,469

(22) Filed: Dec. 16, 2024

(51) Int. Cl. B60H 1/00

(52) U.S. Cl. CPC B60H 1/00585

(57) ABSTRACT

A system and method for rapid recovery of refrigerant from the refrigeration circuit of a vehicle. The method utilizes the compressor of the refrigeration circuits working in tandem with the compressor of a service cart. The recovery finishes using only the compressor of the service cart.

### TECHNICAL FIELD

This disclosure relates to routine operations of air conditioning service carts. In particular, this disclosure is directed to service carts utilized during service and maintenance of air conditioning systems of vehicles.

### BACKGROUND

Modern vehicles comprise air condition systems to provide rider comfort during operation. Service of vehicular refrigeration circuits (for the air conditioning systems of vehicles) rely upon removal of refrigerant from the system, in order to prevent mess in service environments, comply with regulation, and preserve refrigerant for re-use. Removal of refrigerant from refrigeration services relies upon a “recovery” process, typically performed by a technician utilizing a service cart having a storage tank into which the refrigerant is recovered.

Conventional recoveries of refrigerant take a significant amount of time, which provides a bottleneck to professional service environments seeking to optimize throughput of customer vehicles requiring service. What is desired is a way to minimize the amount of time required for a proper and complete refrigerant recovery.

### SUMMARY

One aspect of this disclosure is directed to a method of refrigerant recovery from a vehicle using a service cart having a high-side port and a low-side port each in fluid communication with a refrigeration circuit of the vehicle. The service cart is in data communication with a control interface of the vehicle. The method comprises engaging the high-side port such that it is open and the low-side port such that it is closed, engaging a vehicle compressor of the refrigeration circuit and a cart compressor of the service cart, and opening the low-side port and disengaging the vehicle compressor in response to a high-side pressure data value falling below a first threshold value. The high-side pressure data is generated by a high-side transducer in fluid communication with the high-side port. The high-side port and the low-side port are controlled by a controller in data communication with the high-side transducer. The method utilizes the compressor of the vehicle's refrigeration system in combination with the compressor of the service cart. The controller generates a high-side port control signal controlling the high-side port, a low-side port control signal controlling the low-side port, a vehicle compressor control signal controlling the vehicle compressor, and a cart compressor control signal controlling the cart compressor. In some embodiments, the compressor of the vehicle's refrigeration system may be initiated prior to the method. The method may further comprise disengaging the compressor in response to the high-side pressure data and a low-side pressure data falling below a second threshold value for a window of time. The low-side pressure data is generated by a low-side transducer in fluid communication with the low-side port.

Another aspect of this disclosure is directed to a method of refrigerant recovery from a vehicle using a service cart having a high-side port and a low-side port each in fluid communication with a refrigeration circuit of the vehicle. The service cart is in data communication with a control interface of the vehicle. The method comprises engaging a vehicle compressor of the refrigeration circuit and a cart compressor of the service cart, engaging the high-side port such that it is open and the low-side port such that it is closed, and opening the low-side port and disengaging the vehicle compressor in response to a high-side pressure data value falling below a first threshold value. The high-side pressure data is generated by a high-side transducer in fluid communication with the high-side port. The high-side port and the low-side port are controlled by a controller in data communication with the high-side transducer. The method utilizes the compressor of the vehicle's refrigeration system in combination with the compressor of the service cart. The controller generates a high-side port control signal controlling the high-side port, a low-side port control signal controlling the low-side port, a vehicle compressor control signal controlling the vehicle compressor, and a cart compressor control signal controlling the cart compressor. In some embodiments, the compressor of the vehicle's refrigeration system may be initiated prior to the method. The method may further comprise disengaging the compressor in response to the high-side pressure data and a low-side pressure data falling below a second threshold value for a window of time. The low-side pressure data is generated by a low-side transducer in fluid communication with the low-side port.

A further aspect of this disclosure is directed to a non-transitory processor-readable medium having instructions stored thereon that, when read by a processor in data communication with a control interface of a vehicle and a service cart having a high-side port and a low-side port in fluid communication with a refrigerant circuit of a vehicle with a refrigerant circuit. The instructions cause the processor to perform the steps of engaging the high-side port such that it is open and the low-side port such that it is closed, engaging a vehicle compressor of the refrigeration circuit and a cart compressor of the service cart, and opening the low-side port and disengaging the vehicle compressor in response to a high-side pressure data value falling below a first threshold value. The high-side pressure data is generated by a high-side transducer in fluid communication with the high-side port. The high-side port and the low-side port are controlled by a controller in data communication with the high-side transducer. The method utilizes the compressor of the vehicle's refrigeration system in combination with the compressor of the service cart. The controller generates a high-side port control signal controlling the high-side port, a low-side port control signal controlling the low-side port, a vehicle compressor control signal controlling the vehicle compressor, and a cart compressor control signal controlling the cart compressor. In some embodiments, the compressor of the vehicle's refrigeration system may be initiated prior to the method. The method may further comprise disengaging the compressor in response to the high-side pressure data and a low-side pressure data falling below a second threshold value for a window of time. The low-side pressure data is generated by a low-side transducer in fluid communication with the low-side port.

The above aspects of this disclosure and other aspects will be explained in greater detail below with reference to the attached drawings.

### BRIEF DESCRIPTION OF THE DRAWINGS

FIG. 1 is an illustration of a vehicle and service cart during a service action for an air conditioning system of the vehicle.

FIG. 2 is an illustration of an air conditioning service cart.

FIG. 3 is a circuit diagram depicting a service cart circuit in fluid communication with a refrigeration circuit of a vehicle.

FIG. 4 is a flowchart illustrating a method of refrigerant recovery.

FIG. 5 is an illustration of a vehicle and service cart during a service action for an air conditioning system of the vehicle.

FIG. 6 is an illustration of a vehicle and service cart during a service action for an air conditioning system of the vehicle.

FIG. 7 is an illustration of a vehicle and service cart during a service action for an air conditioning system of the vehicle.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

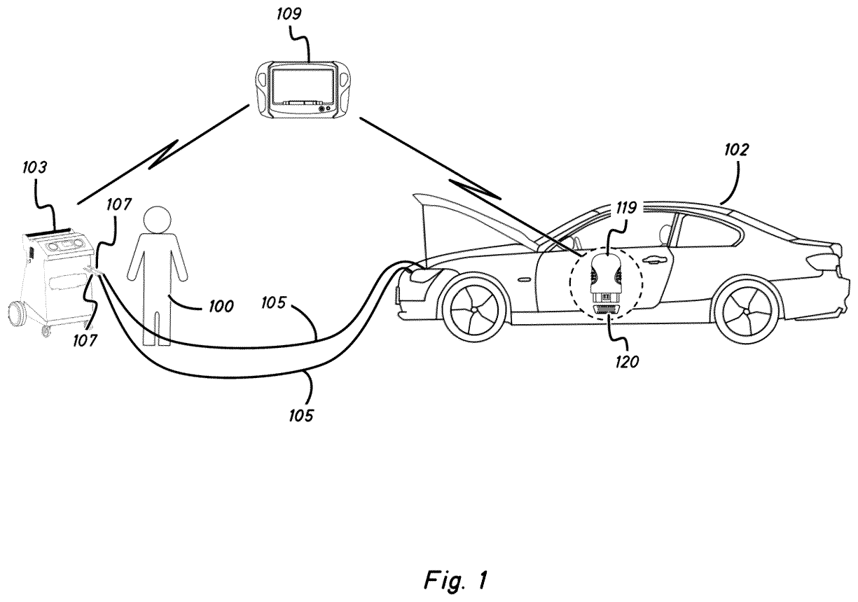

FIG. 1 depicts a use case of a user 100 performing a fluid exchange operation for a vehicle 102 using a service cart 103. In the depicted embodiment, the fluid exchange operation of service cart 103 is directed to the air conditioning system of vehicle 102, but other embodiments may be directed to other fluid exchange services without deviating from the teachings disclosed herein. In the depicted embodiment, refrigerant is moved between the vehicle 102 and service cart 103 via a number of hoses 105 that are coupled at one end to vehicle 102 and at the other end to service cart 103. Each of the hoses 105 are coupled to service cart 103 via a hose connector assembly 107 in an assembled state. In this embodiment, commands from service cart 103 can be relayed to the vehicle 102 to engage functions of the vehicle that are helpful to the fluid exchange service.

In the depicted embodiment, commands and other data may be transmitted from the service cart 103 to a diagnostic tool 109 and then to the vehicle 102 via a dongle 119 in data communication with a control interface 120. In the depicted embodiment, the diagnostic tool 109 advantageously provides a ready connection to transmit commands and other data to vehicle 102, including access to particular command codes that may be used for other service actions, such as diagnostic service actions. In the depicted embodiment, data transmission between the service cart 103 and diagnostic tool 109 is a wireless connection, but other embodiments may comprise other configurations, including wired connections, without deviating from the teachings disclosed herein. In the depicted embodiment, data is exchanged between diagnostic tool 109 and dongle 119 via wireless connection, but other embodiments may comprise other configurations, including wired connections, without deviating from the teachings disclosed herein.

In the depicted embodiment, control interface 120 is represented as an onboard diagnostic port using an onboard diagnostic type-II (OBD-II) protocol, but other embodiments may comprise other configurations without deviating from the teachings disclosed herein. In such embodiment, vehicle 102 may comprise other data input connections suitable to receive external commands or other data. Such embodiments may comprise a firmware or software layer of a vehicle's internal processors or controllers without deviating from the teachings disclosed herein. In the depicted embodiment, it is understood that control interface 120 comprises an OBD-II port in data communication with a diagnostic bus, such as a controller area network (CAN) bus conforming to a CAN protocol, but other embodiments may comprise other configurations without deviating from the teachings disclosed herein. In some such embodiments, control interface 120 may be in data communication with one or more electronic control units (ECU) of vehicle 102, and other embodiments may comprise a different configuration entirely without deviating from the teachings disclosed herein. Advantageously, diagnostic tool 109 may comprise a memory (not shown) providing information and instructions for interfacing with vehicles having different makes and models, which in turn may comprise different protocols, port types, and command messages that are compatible with each vehicle. In this manner, diagnostic tool 109 advantageously may provide a compatibility translation between commands sent by service cart 103 without requiring service cart 103 to have a similarly comprehensive repository of vehicle information for the same range of vehicle makes and models. Some such embodiments of service cart 103 may comprise a memory with this repository information without deviating from the teachings disclosed herein.

In the depicted embodiment, diagnostic tool 109 is embodied as an electronic scan tool in the form of a tablet diagnostic tool. But in other embodiments diagnostic tool 109 may be embodied as a mobile processing device, a smartphone, a tablet computer, a laptop computer, a wearable computing device, a desktop computer, a personal digital assistant (PDA) device, a handheld processor device, a specialized processor device, a system of processors distributed across a network, a system of processors configured in wired or wireless communication, or any other alternative embodiment known to one of ordinary skill in the art.

In the depicted embodiment, data communication is depicted utilizing a wireless connection. One or more of service cart 103, diagnostic tool 109, and dongle 119 may be configured to communicate wirelessly via one or more of an RF (radio frequency) specification, cellular phone channels (analog or digital), cellular data channels, a Bluetooth specification, a Wi-Fi specification, a satellite transceiver specification, infrared transmission, a Zigbee specification, Local Area Network (LAN), Wireless Local Area Network (WLAN), or any other alternative configuration, protocol, or standard known to one of ordinary skill in the art. In embodiments utilizing a wired data communication, one or more of service cart 103, diagnostic tool 109, and dongle 119 may comprise a TCP/IP connection, a local area network (LAN) connection, a plain-old-telephone-service (POTS) connection, an Internet protocol connection, an electrical wiring, a conductive channel, an electrical bus, a fiber optic pathway, or any other alternative embodiment known to one of ordinary skill in the art.

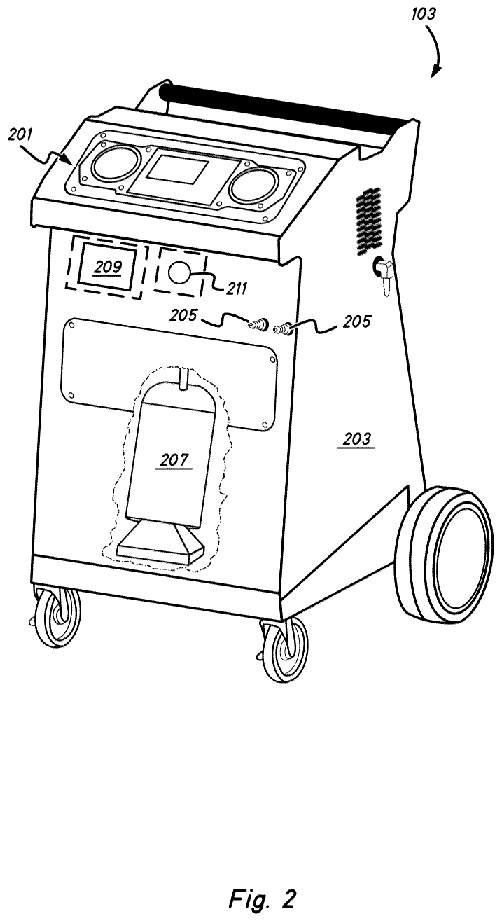

FIG. 2 depicts service cart 103 and components thereof. Service cart 103 comprises a console 201 providing a user with displays and controls for the functions of service cart 103. The chassis 203 of service cart 103 provides support for a number of ports 205 which provide fluid communication with a storage tank 207 at least partially disposed within chassis 203. In the depicted embodiment, ports 205 comprises a high-side port and a low-side port conventional to exchange refrigerant between a vehicle (such as vehicle 102; see FIG. 1) and service cart 103, but other embodiments may comprise other configurations without deviating from the teachings disclosed herein. During service, service cart 103 is operable to transfer refrigerant to and from the vehicle and storage tank 207 via ports 205. This transfer is accomplished utilizing pressure differentials within conduits exhibiting fluid communication between refrigerant circuits of the vehicle under service and also service cart 103.

Service cart 103 additionally comprises a controller 209 in data communication with console 201, the controller operable to process, receive, generate, and transmit commands and other data. In the depicted embodiment, controller 209 may comprise an integrated controller having a processor and a memory, but other embodiments may comprise other configurations without deviating from the teachings disclosed herein. Service cart 103 additionally comprises a transceiver 211 in data communication (not shown) with controller 209. Transceiver 211 is suitable to transmit and receive data and command signals in data communication with external devices (such as diagnostic tool 109; see FIG. 1). In the depicted embodiment, transceiver 211 comprises a combined transmitter and receiver element, but other embodiments may comprise discrete transmitter and receiver elements without deviating from the teachings disclosed herein. In the depicted embodiment, transceiver 211 operates using wireless connectivity, but other embodiments may include wired connectivity additionally or instead of the wireless connectivity without deviating from the teachings disclosed herein.

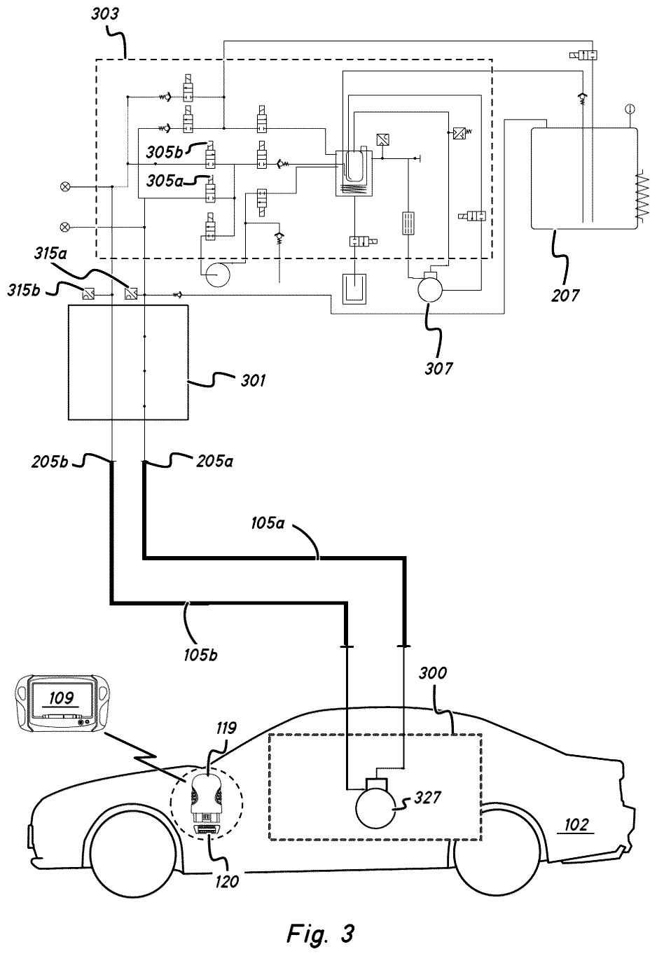

FIG. 3 is a simplified fluid circuit diagram illustrating a refrigeration circuit 300 of vehicle 102 in fluid communication with components of a service cart. It is first noted that in this diagram, intersections of fluid conduits are understood to only be in fluid communication when the intersection is marked with a connection point (i.e., a circular dot defining the fluid intersection). Otherwise, intersecting circuit lines are understood not to be in fluid communication with each other.

Some previously observed elements of the system are observable on this circuit diagram, including hoses 105, diagnostic tool 109, dongle 119, control interface 120, ports 205, and storage tank 207. In this depiction, hoses 105 are organized as high-side hose 105a and low-side hose 105b, each corresponding to the expected pressure as observed in the refrigeration circuit 300. Because the circuit is designed around these expected pressures, additional features of the circuit will additionally be differentiated by their associated with a high-side or low-side of the refrigeration circuit 300. In particular, high-side port 205a is connected to high-side hose 105a and low-side port 205b is connected to low-side hose 105b. The service cart side circuit comprises an injection manifold 301 and a main manifold 303. In this depiction, elements of each of the injection manifold 301 and main manifold 303 may be omitted if they do not relate to the operation of the invention described herein, and additional features may be present without deviating from the teachings disclosed herein.

In the depicted embodiment, monitoring of the high-side and low-side conduits is desired, and is accomplished using a set of transducers 315 in fluid communication with each port. In the depicted embodiment, high-side transducer 315a is in fluid communication with high-side port 205a and high-side inlet solenoid 305a. In the depicted embodiment, high-side transducer 315b is in fluid communication with high-side port 205b and high-side inlet solenoid 305b. Each of the transducers 315 generate pressure data indicating conditions within their respective fluid conduits, and the pressure data is provided to the controller via a data communication connection (not shown). The controller may utilize the pressure data of each fluid conduit to adjust the operational conditions of the components of injection manifold 301 and main manifold 303. Notably, the controller may not have operational control of any element of vehicle 102 without deviating from the teachings disclosed herein, but some embodiments may comprise control of one or more functions of vehicle 102 without deviating from the teachings disclosed herein.

A controller (such as controller 209; see FIG. 2) is able to open and close ports 205 by generating signals to actuate inlet solenoids 305 into an open or closed position. In the depicted embodiment, inlet solenoids 305 comprise a high-side inlet solenoid 305a and a low-side inlet solenoid 305b, each of the inlet solenoids 305 effectively opening or closing fluid communication at their associated port 205. Main manifold 303 is additionally in fluid communication with a cart compressor 307 that can be used to initiate flow of refrigerant through the manifolds and also refrigeration circuit 300 when hoses 105 are connected in fluid communication between the service cart circuit and refrigeration circuit 300. In the depicted embodiment, a vehicle compressor 327 associated with refrigeration 300 is additionally depicted. Vehicle compressor 327 is utilized by the vehicle during normal operation of the refrigeration circuit 300 to generate cool air for the passenger cabin of the vehicle, but in both normal operation and during service vehicle compressor 327 is additionally able to circulate refrigerant through the circuits and manifolds depicted. In the depicted embodiment, vehicle compressor 327 can be controlled externally (such as by controller 209; see FIG. 2) by control signals received at control interface 120. In the depicted embodiment, the control signals are received via a wireless transmission from diagnostic tool 109 to dongle 119, but other embodiments may comprise other configurations without deviating from the teachings disclosed herein. The control signals may be received at the control interface 120 and directly or indirectly control vehicle compressor 327. By way of example, and not limitation, control signals may be suitable to be received by an ECU (not shown) of vehicle 102 that controls vehicle compressor 327, or the signals may be directed to a central ECU within a diagnostic bus that relays the commands to control vehicle compressor 327 without deviating from the teachings disclosed herein. In some embodiments, the activity of vehicle compressor 327 may be incremental (i.e., a “high” versus “low” setting or the like) and other configurations may only comprise binary activity (i.e., “on” versus “off” only) without deviating from the teachings disclosed herein.

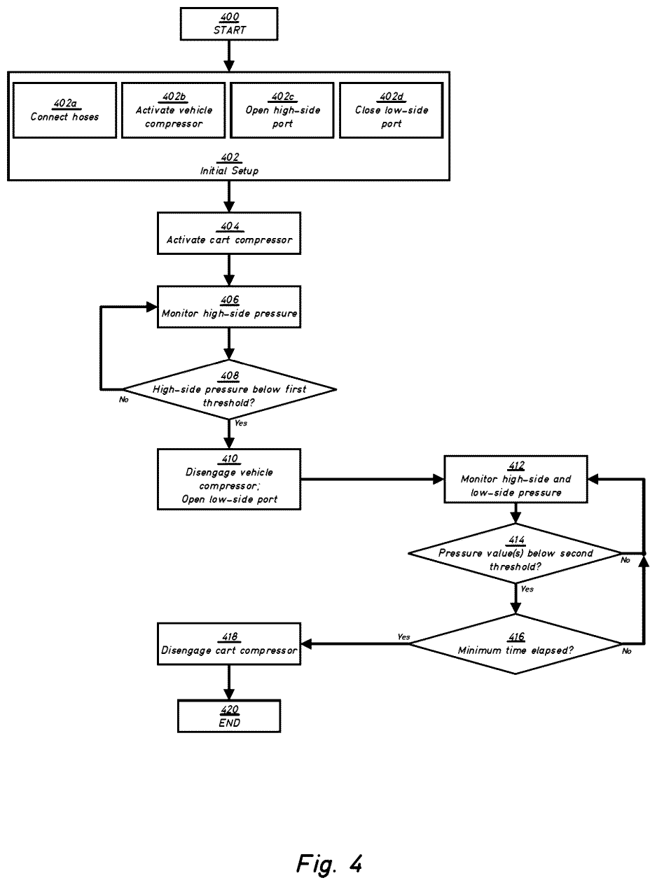

FIG. 4 is a flowchart illustrating a method utilizing a service cart (such as service cart 103; see FIG. 1, FIG. 2) in fluid communication with a refrigeration circuit of a vehicle (such as refrigeration circuit 300; see FIG. 3) for a rapid recovery process according to the teachings disclosed herein.

The method starts at step 400 and proceeds to an initial setup at step 402. The initial setup is comprised of a number of sub-steps that may be accomplished in any order, concurrently, or in any combination of partially concurrent orders without deviating from the teachings disclosed herein. In the depicted embodiment, it is preferred that step 402a is completed first, where hoses (such as hoses 105; see FIG. 1, FIG. 3) are connected between the high-side port and low-side port of the service cart and corresponding ports of the vehicle. Connecting hoses at step 402a advantageously prevents any accidental spillage or leakage of refrigerant during the recovery. In order to maximize the efficiency of the rapid recovery, the compressor associated with the vehicle refrigerant circuit (such as vehicle compressor 327; see FIG. 3) should be activated, which is accomplished in step 402b. Typically, this activation is accomplished by placing the air conditioning circuit of the vehicle in an active state within the cabin of the vehicle. However, in the depicted embodiment, this may advantageously instead be achieved by transmitting a control signal to activate the vehicle compressor by a controller (such as controller 209; see FIG. 2). The ability of a user to activate the vehicle compressor from outside the cabin of the vehicle advantageously makes the service operation more convenient, more efficient, and faster.

Additionally in the initial setup step 402, the high-side port of the service cart should be placed in an open condition and the low-side port of the service cart should be placed in a closed condition. At step 402c it is ensured that the high-side port of the service cart is open: including opening the high-side port if it is closed or partially open, and leaving the high-side port open if it is already in an open state. At step 402d it is ensured that the low-side port is closed: including closing the low-side port if it is open or partially open, and leaving the low-side port closed if it is already in an open state.

After all the sub-steps of step 402 are complete, the system has been placed into an appropriate initial condition to begin the recover process, and the compressor of the service cart (such as cart compressor 307; see FIG. 3) is activated at step 404. At this point, both the vehicle-side compressor and the cart-side compressor are working in tandem to maximally transfer refrigerant from the refrigeration circuit of the vehicle into the storage tank (such as storage tank 207; see FIG. 2) of the service cart. This maximal transfer is accomplished because only the high-side conduit is in a state of active fluid communication while the low-side port is closed, and additional pressure to increase flow is achieved by simultaneous pumping of the vehicle-side compressor and the cart-side compressor concurrently.

This tandem utilization of both compressors results in a much faster transfer of refrigerant than relying upon the cart-side compressor alone. However, the finite amount of refrigerant available means that as refrigerant is captured into the storage tank of the service cart, the pressure experienced at the high-side port will necessarily decrease as the remaining refrigerant decreases in volume and can no longer sustain the increased pressure level. Modern vehicles are typically equipped with a sensor and shut-off failsafe that deactivates the vehicle-side compressor when a loss of pressure is detected in the refrigerant circuit. This failsafe is intended to prevent continued flushing of refrigerant into the atmosphere in response to a leak in the circuit, but in this case may advantageously be utilized to provide an indication that the bulk of the refrigerant in the circuit has been recovered from the vehicle circuit and into the storage tank.

In order to capitalize on this failsafe mechanism properly, the method at step 406 monitors the pressure of the high-side port. If the high-side pressure remains above a first threshold at step 408, the method returns to step 406 to acquire additional pressure data. Once the pressure at the high-side port falls below the first threshold, the method instead proceeds to step 410. At step 410, the method ensures that the vehicle compressor has been disengaged utilizing control signals sent by a controller (such as controller 209; see FIG. 2). This advantageously allows the method to functionally operate even in the event that the vehicle does not have a functioning failsafe shut-off for the vehicle compressor. Other embodiments may not utilize this shut-off signal without deviating from the teachings disclosed herein.

The value of the first threshold will depend upon the make and model of the vehicle, and its corresponding shutoff conditions for the refrigeration circuit. For this reason, the first threshold is a selectable threshold, and may be input by a user to a controller using a console (such as console 201; see FIG. 2). By way of example, and not limitation, the first threshold may be selectable in a range of 30 to 400 pounds per square inch (PSI), as a typical pressure experienced when both the vehicle-side and cart-side compressors are operating may be in the range of 150 to 350 PSI, while cart-side only compressor recovery may exert 30 to 50 PSI. In some embodiments, the first threshold may be set to detect when the pressure falls to within a range of 30 to 50 PSI without deviating from the teachings disclosed herein. In such embodiments, the first threshold has been selected to respond to a detection that only a pressure consistent with the cart-side compressor being in activation is observed.

Once it is understood that the vehicle-side compressor is no longer active, the remaining recovery process should be accomplished utilizing only the cart-side components. At step 410, the low-side port is opened, and the recovery process continues utilizing just the cart-side compressor. Note that in the depicted embodiment, the vehicle-side compressor is automatically shut off without any intervention from the service cart.

The end of the second phase of recovery is determined when the recovery has driven the refrigeration circuit down to a vacuum or near-vacuum conditions (depending on the specification of the vehicle based upon make and model). For this reason, the method continues to step 412, where the high-side and low-side pressures are monitored. At step 414, the pressure data is observed to determine if one or both of the high-side pressure data or the low-side pressure data indicates that pressure has fallen below a second threshold. If not, the method returns to step 412 to generate additional pressure data. If some embodiments, both the high-side and low-side pressure being blow the second threshold may be suitable to advance past step 414, but other embodiments may require both values to be below the second threshold without deviating from the teachings disclosed herein. Once the pressure data has dropped below the second threshold, the method proceeds to step 416, where a timer is initiated upon the first instance of step 416. If a minimum amount of time has not elapsed since the timer has been initiated, the method returns to step 412. Note that the timer is not reset by either step 412 or 414, nor by additional reentry into step 416. In this manner, the timer provides a continuous window time has elapsed since the initial point at which the pressure fell below the second threshold. Once the minimum window of time has elapsed, it is understood that that circuit has been reduced to the requisite vacuum or near-vacuum conditions, and the method proceeds to step 418, where the cart-side compressor is disengaged and the timer is reset. The method then ends at step 420.

In the depicted embodiment, the second threshold value is selectable according to the specification of the cart-side compressor. By way of example, and not limitation, the second threshold may be a value below 1 PSI, but other embodiments may comprise other values without deviating from the teachings disclosed herein. In some embodiments, the second threshold may be selected by a user via a console (such as console 201; see FIG. 2) in order to accommodate manufacturer specifications for different makes and models of vehicle, or to accommodate a change in operating conditions of the cart-side compressor.

In the teachings herein, the window of time may be selected by a user and input using a console (such as console 201; see FIG. 2) in order to accommodate a variety of specifications according to the make and model of the vehicle, or the operating conditions of the service cart. In some embodiments, the window of time may be set to 0 milliseconds, effectively eliminating step 416 from the method without deviating from the teachings disclosed herein. Some embodiments of the method may not comprise a step 416 at all without deviating from the teachings disclosed herein. In other embodiments, the window of time may be a value less than 10 seconds without deviating from the teachings disclosed herein.

This method advantageously improves over the operational time of a conventional, single-compressor recovery. It has been shown experimentally that utilization of this method can result in an improvement in recovery time from a conventional time on the order of 15 minutes to an improved time of 6 minutes or less utilizing this rapid recovery method.

In the depicted embodiment, the high-side pressure data and low-side pressure data are generated by transducers in fluid communication with the respective ports (such as high-side transducer 315a and low-side transducer 315b; see FIG. 3). The transducers may be in data communication with a controller that is configured to operate components of a service cart, including a high-side port and low-side port. In some embodiments, the pressure data may be presented to a user via a human-machine interface (such as console 201; see FIG. 2), and the user may provide inputs indicating control via a console (such as console 201; see FIG. 2) without deviating from the teachings disclosed herein.

The preferred embodiment of the disclosed invention utilizes a controller responding to instructions provided by a non-transitory computer readable medium. In the depicted embodiments, the controller may be embodied as single-function processor, but may instead comprise a mobile processing device, a smartphone, a tablet computer, a laptop computer, a wearable computing device, a desktop computer, a personal digital assistant (PDA) device, a handheld processor device, a specialized processor device, a system of processors distributed across a network, a system of processors configured in wired or wireless communication, or any other alternative embodiment known to one of ordinary skill in the art. Instructions for the controller may be provided by a non-transitory computer-readable medium. In the depicted embodiment, the non-transitory computer-readable medium may comprise a programmable memory, but other embodiments may be embodied as a non-transitory computer-readable storage medium or a machine-readable medium for carrying or having computer-executable instructions or data structures stored thereon. Such non-transitory computer-readable storage media or machine-readable medium may be any available media embodied in a hardware or physical form that can be accessed by a general purpose or special purpose computer. By way of example, and not limitation, such non-transitory computer-readable storage media or machine-readable medium may comprise random-access memory (RAM), read-only memory (ROM), electrically erasable programmable read-only memory (EEPROM), optical disc storage, magnetic disk storage, linear magnetic data storage, magnetic storage devices, flash memory, or any other medium which can be used to carry or store desired program code means in the form of computer-executable instructions or data structures. Combinations of the above should also be included within the scope of the non-transitory computer-readable storage media or machine-readable medium.

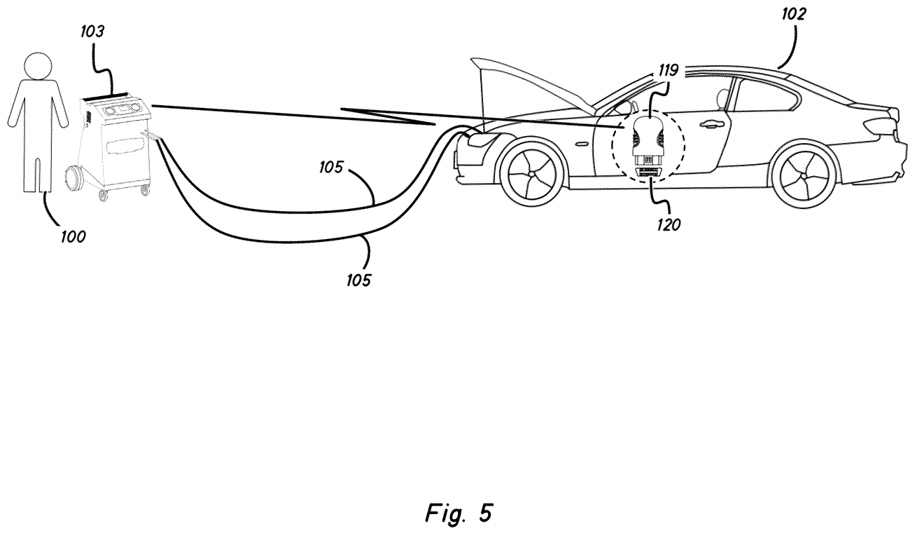

Alternative configurations of systems may be utilized with different configurations of a service cart or vehicle without deviating from the teachings disclosed herein. FIG. 5 depicts an instance of a service cart 103 that is capable of direct data communication with a dongle 119, rather than utilizing an intermediary device (such as diagnostic tool 109; see FIG. 1). In the depicted embodiment, service cart 103 may comprise a memory (not shown) storing thereon information about compatible makes and models of vehicles for service, as well as corresponding commands to access functions of the vehicles (such as a vehicle compressor like vehicle compressor 327; see FIG. 3). In the depicted embodiment, service cart 103 is in wireless connectivity with dongle 119, but other embodiments may comprise a wired connection without deviating from the teachings disclosed herein.

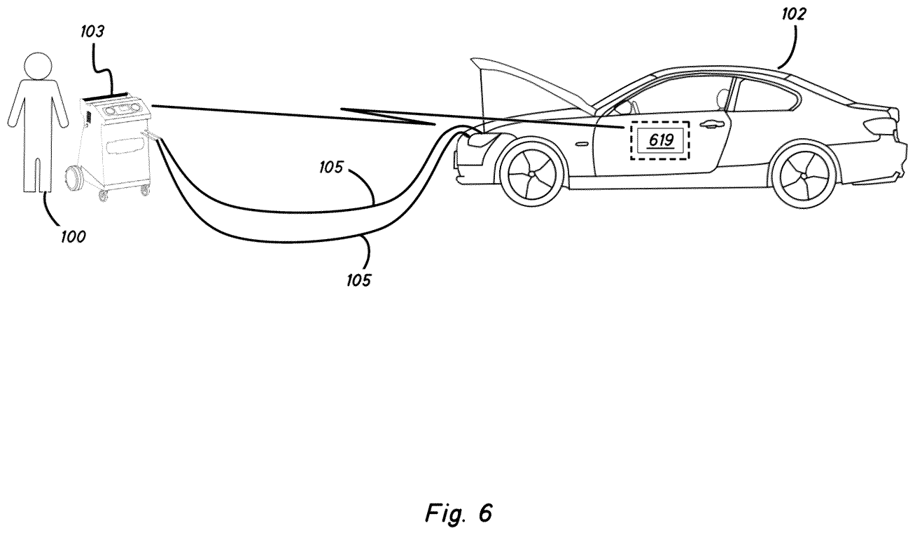

Some modern vehicles do not have an external control interface, such as an OBD-II diagnostic port (see FIG. 1), FIG. 6 depicts and embodiment wherein vehicle 102 instead comprises a native control interface 619 suitable to provide data communication with external devices. Native control interface 619 is an alternative embodiment not relying upon a dongle connection (such as dongle 119; see FIG. 1) and instead providing wireless connectivity. In the depicted embodiment, service cart 103 is in direct wireless connection with native control interface 619, but other embodiments may utilize a wired connection or an intermediary device (such as diagnostic tool 109) without deviating from the teachings disclosed herein. In the depicted embodiment, native control interface 619 comprises a firmware embodiment with a hardware transceiver element, but other embodiments may utilize a different configuration of hardware, software, and firmware elements without deviating from the teachings disclosed herein.

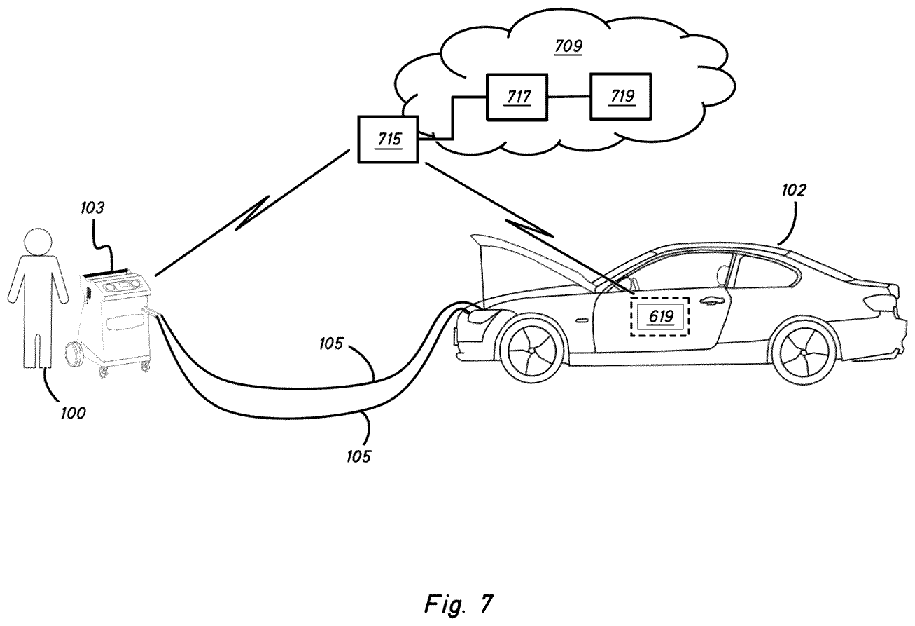

Notably, manufacturers may change standards for new vehicles as they adjust their designs from model to model of vehicles, and as such it may be advantageous to have a dynamic repository of information regarding vehicle control signals and accessibility. FIG. 7 depicts an embodiment of the system that utilizes as an intermediary device a cloud diagnostic server 709. The cloud diagnostic server 709 is typically an offsite server that can be advantageously dynamically updated with additional vehicle information in response to new standards and designs used by vehicle manufacturers. In the depicted embodiment, cloud diagnostic server 709 is in wireless communication with service cart 103 and vehicle 102 via a native control interface 619, but other embodiments may comprise wired connections or different vehicle configurations without deviating from the teachings disclosed herein. In the depicted embodiment, cloud diagnostic server comprises a transceiver 715 suitable to establish and conduct data communication between other devices (such as service cart 103 and vehicle 102), a cloud processor 717 to execute instructions and process data, and a memory 719 suitable to provide instructions for processor 717 and host a repository of vehicle information for service. Other embodiments may comprise other configurations without deviating from the teachings disclosed herein. By way of example and not limitation, cloud diagnostic server 709 may comprise discrete transmitter and receiver elements rather than a singular transceiver 715 without deviating from the teachings disclosed herein. By way of example and not limitation, cloud diagnostic server may comprise multiple memories with specialized functions, rather than a singular memory 719 without deviating from the teachings disclosed herein. Other embodiments may comprise other configurations without deviating from the teachings herein.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A method of refrigerant recovery from a vehicle using a service cart high-side port and a low-side port each in fluid communication with a refrigeration circuit of the vehicle, the service cart in data communication with a control interface of the vehicle, the method comprising:
engaging the high-side port such that it is open and the low-side port such that it is closed;
engaging a vehicle compressor of the refrigeration circuit and a cart compressor of the service cart; and
opening the low-side port and disengaging the vehicle compressor in response to a high-side pressure data value falling below a first threshold value,
wherein
the high-side pressure data is generated by a high-side transducer in fluid communication with the high-side port,
the high-side port and the low-side port are controlled by a controller in data communication with the high-side transducer, and
the controller generates a high-side port control signal controlling the high-side port, a low-side port control signal controlling the low-side port, a vehicle compressor control signal controlling the vehicle compressor, and a cart compressor control signal controlling the cart compressor.

2. The method of claim 1, wherein the controller is a component of a diagnostic tool.

3. The method of claim 1, wherein the controller is a component of the service cart.

4. The method of claim 1, wherein the service cart is in digital communication with the control interface using a wireless connection.

5. The method of claim 1, wherein the steps of engaging the vehicle compressor, engaging the cart compressor, and engaging the high-side port and the low-side port are performed concurrently.

6. The method of claim 1, further comprising:
disengaging the compressor in response to the high-side pressure data and a low-side pressure data falling below a second threshold value for a window of time,
wherein
the low-side pressure data is generated by a low-side transducer in fluid communication with the low-side port, and
the compressor is controlled by the controller.

7. The method of claim 6, wherein the window of time is selectable.

8. The method of claim 6, wherein the second threshold value is selectable.

9. The method of claim 1, wherein the first threshold is selectable.

10. The method of claim 1, wherein the first threshold is 150 psi or less.

11. The method of claim 10, wherein the first threshold is 50 psi or less.

12. A method of refrigerant recovery from a vehicle using a service cart high-side port and a low-side port each in fluid communication with a refrigeration circuit of the vehicle, the service cart in data communication with a control interface of the vehicle, the method comprising:
engaging a vehicle compressor of the refrigeration circuit and a cart compressor of the service cart;
engaging the high-side port such that it is open and the low-side port such that it is closed; and
opening the low-side port and disengaging the vehicle compressor in response to a high-side pressure data value falling below a first threshold value,
wherein
the high-side pressure data is generated by a high-side transducer in fluid communication with the high-side port,
the high-side port and the low-side port are controlled by a controller in data communication with the high-side transducer, and
the controller generates a high-side port control signal controlling the high-side port, a low-side port control signal controlling the low-side port, a vehicle compressor control signal controlling the vehicle compressor, and a cart compressor control signal controlling the cart compressor.

13. The method of claim 12, wherein the controller is a component of a diagnostic tool.

14. The method of claim 12, wherein the controller is a component of the service cart.

15. The method of claim 12, wherein the service cart is in digital communication with the control interface using a wireless connection.

16. The method of claim 12, wherein the steps of engaging the vehicle compressor, engaging the cart compressor, and engaging the high-side port and the low-side port are performed concurrently.

17. The method of claim 12, further comprising:
disengaging the compressor in response to the high-side pressure data and a low-side pressure data falling below a second threshold value for a window of time,
wherein
the low-side pressure data is generated by a low-side transducer in fluid communication with the low-side port, and
the compressor is controlled by the controller.

18. A non-transitory processor-readable medium having instructions stored thereon that, when read by a processor in data communication with a control interface of a vehicle and a service cart having a high-side port and a low-side port in fluid communication with a refrigerant circuit of a vehicle with an engaged refrigerant circuit, cause the processor to perform the steps of:
engaging a vehicle compressor of the refrigeration circuit and a cart compressor of the service cart;
engaging the high-side port such that it is open and the low-side port such that it is closed; and
opening the low-side port and disengaging the vehicle compressor in response to a high-side pressure data value falling below a first threshold value,
wherein
the high-side pressure data is generated by a high-side transducer in fluid communication with the high-side port,
the high-side port and the low-side port are controlled by a controller in data communication with the high-side transducer, and
the controller generates a high-side port control signal controlling the high-side port, a low-side port control signal controlling the low-side port, a vehicle compressor control signal controlling the vehicle compressor, and a cart compressor control signal controlling the cart compressor.
